(19) United States
(12) Patent Application Publication
(10) Pub. No.: US 2002/0103066 A1
(43) Pub. Date: Aug. 1, 2002

(54) System and method for variable color-coding and variable length cutting of tubes

(76) Inventor: Dmitry Ostrovsky, Canton, MA (US)

Correspondence Address: BROMBERG & SUNSTEIN LLP, 125 SUMMER STREET, BOSTON, MA, 02110-1618, US

(21) Appl. No.: 09/772,161

(22) Filed: Jan. 29, 2001

(51) Int. Cl. B31C 11/02

(52) U.S. Cl. 493/287

(57) ABSTRACT

A machine for variable color-coding and variable length cutting of tubes dynamically and on demand is described. The machine preferably includes a tube feeder for moving tubing through the system, a color-coding unit for applying a desired color code to the moving tube, a cutting unit and a programmable control unit. The programmable control unit which operates the color-coding and the cutting units uses a known speed at which the tube is moving through the system to compute the times at which to activate and deactivate those units and thereby generate tubes having the desired color-codes and lengths.

### BACKGROUND OF THE INVENTION

1. Field of the Invention

The present invention relates to the manufacture of medical equipment and, more specifically, to an on demand system and method for variable color-coding and variable length cutting of tubes for use in medical equipment.

2. Background Information

Today, many types of fixed or re-usable medical equipment use disposable components, sometimes called “disposable sets”, to avoid having to clean the equipment and to reduce the risk of contamination when the equipment is used by multiple patients. Many of these disposable sets include one or more lengths of plastic tubing. Where numerous tubings are used in one disposable set, it is desirable that each tube be identifiable so that, during assembly of the disposable set, the tubes may be connected to the correct receptacles. In many instances, the correct placement of the tubes within corresponding equipment may be extremely critical. For example, in a blood dialysis machine, tubes that are meant to carry saline need to be connected to the receptacles that contain saline, while tubes that are meant to carry blood need to be connected to receptacles that contain blood. If the two tubes are switched, serious consequences may occur.

Color-coding is one method that is can be used to avoid such problems. In particular, different color-coded tubes that match the colors of the receptacles to which they are to be connected can be used. The different tube colors may even indicate or suggest the different fluids that the tubes are meant to carry. In order to make disposable sets having color-coded tubes, a medical equipment manufacturer typically orders tubes of various lengths and colors from a tube manufacturer. The tube manufacturer then modifies its manufacturing process so as to ink or add a color stripe to the tube at the time it is being made, i.e., during the extrusion process. The addition of color, however, slows down the speed at which the tubes are manufactured, thereby increasing their costs. For example, color-coded tubing can be twice as expensive as single color (e.g., transparent) tubing. The tubing manufacturer then cuts the colored tubes to the desired lengths and each set of tubes having a given color/length combination is separately organized, typically into bins, and shipped to the medical equipment manufacturer for use in assembling the disposable sets.

Not only does this approach result in higher costs tubes, it also increases the medical equipment manufacturer's costs of assembling the disposable sets. For instance, rather than simply maintaining a large supply of a single colored tube, the medical equipment manufacturer must now keep on hand tubes having various different colors is and lengths so as to ensure a constant supply during assembly of the disposable sets. As the number of different disposable sets and/or the number of color/length combinations increases, it becomes more and more difficult to keep track of which particular tubes may need to be replenished. Furthermore, should the supply of tubes of a given color/length combination run out, assembly of the corresponding disposable sets is typically halted until a new supply of tubes having the correct color/length combination can be obtained. Sometimes, it can take days if not weeks for a new supply to be received. This can result in significant delays in the delivery of the corresponding disposable sets.

### SUMMARY OF THE INVENTION

Briefly, the present invention is directed to a system and method for variable color-coding and variable length cutting of tubes rapidly and on demand. In the illustrative embodiment, the system includes a tube puller or feeder for moving a tube at a constant speed, a color-coding unit, a cutting unit and a programmable control unit that is operatively coupled to the color-coding and cutting units. Blank tube is preferably supplied to the system from a drum containing a continuous coil of tube. The supply of tube is provided to the puller which drives or moves it through the color-coding and cutting units at a predetermined speed. The color-coding unit includes one or more ink jet heads that are positioned to “print” on the tube as it moves through the system. The programmable control unit is configured with the speed at which the tube moves through the system and the relative locations of the color-coding and cutting units. By selectively activating and deactivating both the color-coding and cutting units at precise times, the control unit can produce tubes having any desired color and length combination rapidly and on demand.

### BRIEF DESCRIPTION OF THE DRAWINGS

The invention description below refers to the accompanying drawings, of which:

FIG. 1 is a highly schematic, block diagram of the system of the present invention;

FIG. 2 is a highly schematic, block diagram of the programmable control unit of the system of FIG. 1;

FIG. 3 is a flow diagram of the method of the present invention;

FIGS. 4 and 5 are highly schematic block diagrams of alternative embodiments of the color-coding unit of FIG. 1;

FIGS. 6 and 7 are illustrations of exemplary tube segments coded in accordance with the present invention; and

FIGS. 8A and 8B are highly schematic block diagrams of the color-coding unit configured to operate on multi-lumen tubing.

### DETAILED DESCRIPTION OF AN ILLUSTRATIVE EMBODIMENT

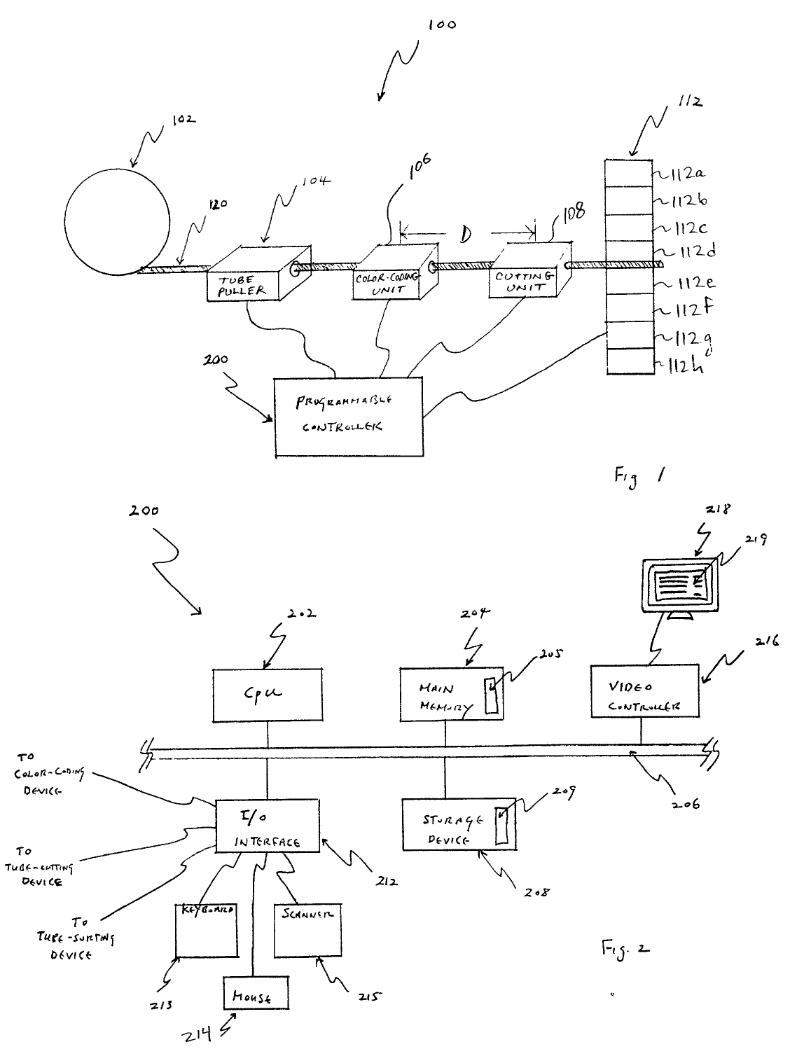

FIG. 1 is a block diagram of a system 100 for producing tubes of various colors and lengths for use in the manufacturing of medical equipment, especially disposable sets. The system 100 includes a tube feeder or puller 104, a color-coding unit 106, a cutting unit 108 and a programmable control unit 200. Programmable control unit 200 is coupled to the color-coding and cutting units 106 and 108. Tubing is preferably supplied to the system 100 by a spool or drum 102 that contains a continuous length of blank tube 120. In particular, the tube 120 may be transparent or a single color, such as white. A moveable tube sorting or handling device 112 having a plurality of bins 112a-h may be provided to receive tubes that have been coded with specific colors and cut to specific lengths by the system 100. The programmable control unit 200 may also be coupled to the tube puller 104 and/or the tube sorting device 112.

The color-coding unit 106 preferably contains one or more print heads, such as ink jet heads, and each print head is adapted to print with a certain color. It should be understood that the color-coding unit 106 may include a single ink jet head for printing with black ink. Suitable ink jet heads for use with the present invention are commercially available from Hewlett Packard Company of Palo Alto, Calif. The cutting unit 108 preferably includes one or more cutting devices, such as knives or other sharp edges, that are designed to cut the tube 120. Suitable cutting devices are commercially available from Tecnoideal S.R.L. of Mirandola, Italy. Tube puller 104 may contain one or more pairs of opposing rollers that are driven by an electric motor so as to move the tube at one or more constant speeds.

FIG. 2 is a highly schematic block diagram of the programmable control unit 200. Unit 200 preferably includes a Central Processing Unit (CPU) 202 that is connected, through a bi-directional bus 206, to a main memory 204 and a storage device 208. The storage device 208 contains a database 209 having a plurality of entries or records. Each entry or record of database 209 specifies a particular color and a particular length for application to tube 120. The number of entries generally corresponds to the number of various colors and lengths of tubes required by the various disposable sets being manufactured. Preferably, unit 202 further includes an input/output (I/O) interface 212, to which a keyboard 213, a mouse 214 and/or a scanner 215 are coupled, to allow for the input of information by a system operator.

The color-coding unit 106 (FIG. 1) may be coupled to the I/O interface 212 and print according to print signals or commands transmitted by the CPU 202. The cutting unit 108 may likewise be coupled to I/O interface 212 and cut the tube according to cut signals or commands transmitted by the CPU 202.

In addition, an application program or process 205 is preferably installed onto or loaded into main memory 204. The application program 205, among other things, directs the CPU 202 to generate a Graphical User Interface (GUI) 219. The GUI 219 is preferably displayed on a display device 218, such as a monitor, that is controlled by a video or graphics controller 216 which is also coupled to the bus 206.

Programmable control unit 200 may be a general purpose personal computer (PC) such as the PCs commercially available from Compaq Computer Corp of Houston, Tex. and controlled by a Windows operating system from Microsoft Corporation of Redmond, Washington, and/or from Apple Computer Inc. of Cupertino, Calif. Alternatively, the programmable control unit 200 may be a customized circuit such as an Application Specific Integrated Circuit (ASIC) including a micro-controller. Storage device 208 may be a semi-conductor device such as a hard drive, zip drive, Read-Only Memory (ROM), Flash memory and the like, or it may be a magnetic or an optical disk device.

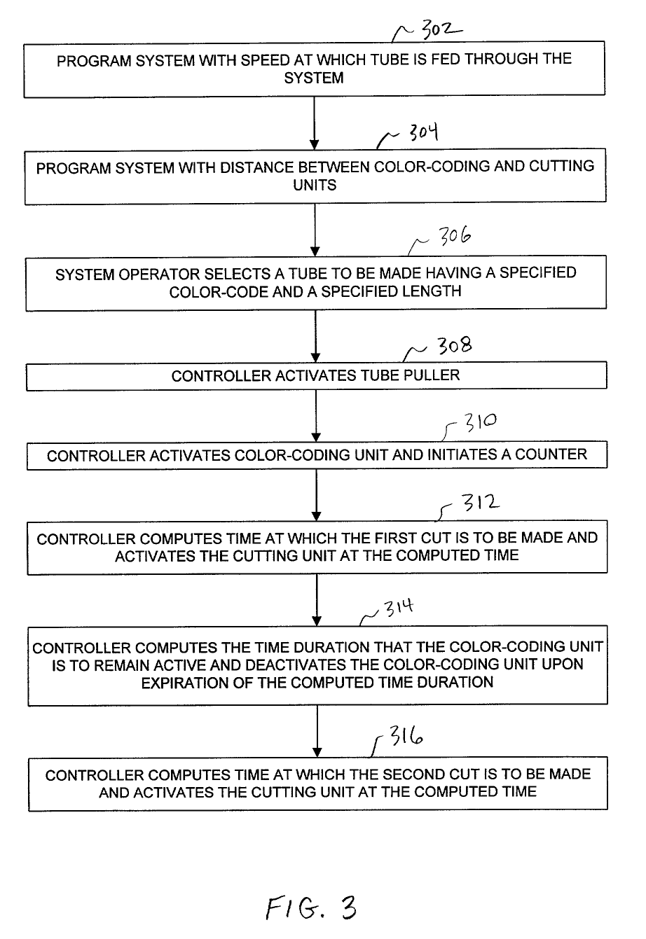

FIG. 3 is a flow diagram of a preferred method according to the present invention. In operation, the programmable control unit 200 is programmed or configured with the speed, e.g., V_{tube}, at which tube 120 is moved through the system 100 by operation of tube puller 104, as indicated at block 302. The unit 200 is also configured with the distance, D (FIG. 1), separating the color-coding and cutting units 106 and 108, as measured along the run of the tube 120 between those two units 106 and 108, as indicated at block 304. This information, which may be inputted by the system operator, may be stored at storage device 208, main memory 204 or at other locations. A first end of the tube 120 from coil 102 is then fed through the system 100. Specifically, the tube 120 is routed between the rollers of the tube puller 104, and through the color-coding and cutting units 106 and 108 so to be operated upon by each of them.

Next, the system operator specifies a tube having a specific color and a specific length to be produced by the system 100, as indicated at block 306. In the illustrative embodiment, program 205 accesses database 209 and, using the GUI 219, presents one or more tube color/length combinations to the system operator for selection. The system operator may use the keyboard 213 and/or the mouse 214 to select the color and length of tubing that is desired. The system operator may also specify the quantity of tubes to be generated with the specified color and length.

Upon selection of the color and length, system 100 proceeds to produce the requested tube(s). More specifically, the programmable control unit 200 activates the tube puller 104, thereby causing tube 120 to be uncoiled from drum 102 and moved through the system 100 at the preconfigured speed, as indicated at block 308. Programmable control unit 200 then directs color-coding unit 106 to begin applying the selected color to the tube 120 as it moves or passes through unit 106, as indicated at block 310. It also starts a counter (not shown) at the same time that it activates the color-coding unit 106, as also indicated by block 310. The programmable control unit 200 then computes the time at which the cutting unit 108 is to be activated in order to create a first end of the specified tube, as indicated at block 312. Specifically, the unit 200 computes the amount of time, e.g., T_{cut}_{_{—}}_{first}_{_{—}}_{end}, that it will take the point of tube 120 at which the specified color was first applied to reach the cutting unit 108. This time is D/V_{tube}. When the counter reaches the computed T_{cut}_{_{—}}_{first}_{_{—}}_{end} time value, unit 200 activates the cutting unit 108, thereby creating the first end of the selected tube, as also indicated by block 312.

The programmable unit 200 also computes the amount of time, e.g., T_{color}, that the selected color is to be applied to the tube 120 so as to produce a colored tube of the desired length, as indicated at block 314. T_{color} equals the selected tube length divided by V_{tube}. When the programmable control unit's counter reaches the computed T_{color} time, unit 200 deactivates the color-coding unit 106, thereby stopping the application of color to the blank tube 120, as also indicated by block 314. Unit 200 next determines the time, e.g., T_{cut}_{_{—}}_{second}_{_{—}}_{end}, at which the cutting unit 108 is to be activated in order to create the second end of the tube 120, as indicated at block 316. This time value also equals D/V_{tube}. When the computed T_{cut}_{_{—}}_{second}_{_{—}}_{end} time value has elapsed as measured from the time at which the color-coding unit 106 was deactivated, unit 200 activates cutting unit 108, thereby creating the second end of the tube, as also indicated by block 316.

This tube which has the desired color and the desired length may then be placed in a selected bin, e.g., bin 112d, by operating, e.g., elevating, the tube sorting device 112 until bin 112d is properly positioned to receive the cut tube from the cutting unit 108. For example, the elevation of the bins 112a-h may be controlled by a motor (not shown) which, in turn, is controlled by the programmable control unit 200. The programmable control unit 200 preferably stores the current position of the sorter 112, and is thus able to position the sorter 112 so that the desired bin, e.g., bin 112d, may receive the next color-coded segment of tube 120.

This process is preferably repeated for each particular tube color and length that is desired by the system operator. The system operator, moreover, may specify a number of tubes having different color and/or length combinations at step 306. In this case, the system 100 proceeds to generate the specified tubes one after the other without interruption. Because the programmable control unit 200 stores a database of various color and length combinations, system 100 (FIG. 1) is able to generate tubes of different colors and lengths dynamically and on demand.

It should be understood that instead of having a tube puller 104, a motor controlled by programmable control unit 200 may be coupled to spool 102 for rotating the spool 102 and thereby unwinding or uncoiling the tube 120 and moving it through the system. It should be further understood that although in the illustrative embodiment the tuber puller 104 moves the tube 120 at a predetermined constant speed through the system 100, puller 104 may have multiple operating speeds any of which could be selected by the programmable control unit 200.

As shown, the programmable control unit 200 uses the speed at which tube 120 is moved through the system 200 and the distance D between the color-coding and cutting units 106 and 108 to operate those units and thus produce tubes having the desired color and length characteristics.

It should be understood that unit 200 need not include database 209. In particular, CPU 202 may be alternatively or additionally programmed to present the system operator with a GUI 219 that requests the color, length and quantity of desired tubes. That is, GUI 219 may have a plurality of fields for receiving such information. Upon entering this information, the programmable control unit 200 causes the color-coding unit 106 (FIG. 1) and the tube-cutting device 108 to produce the requested tube(s) in a manner as described above. In another embodiment, CPU 202 may be programmed to present the system operator through GUI 219 with a list of different disposable sets, e.g., by model number, name, etc., to be assembled or manufactured. This information is then mapped within database 209 to the exact number, length and color of tubes needed for the respective disposable set. Upon selection of a particular disposable set, the programmable control unit 200 searches database 209 to determine the number, color-coding and length of the tubes required for the selected equipment. The system 100 then proceeds to generate the requisite color-coded tubes each having the proper length for use with the selected disposable set. In this way, the manufacturer need not store in its inventory multitudes tubes of different colors and lengths, some of which may ultimately never be used. Of course, GUI 219 may also be controlled to generate a field into which the system operator may enter the corresponding the medical equipment by model number, name, etc. onto which the disposable set is to be loaded.

According to another embodiment of the present invention, scanner 215 may be used with a booklet or a table (not shown) that contains barcodes corresponding to tubes of various color-codes and lengths. Again, these barcode values may be mapped to the corresponding colors and lengths. The system operator uses the scanner 215 to scan the barcode corresponding to the tube having the color and length that is required. Upon scanning the bar code, the programmable control unit 200 searches database 209 for the entry that matches the scanned bar code. The matching entry from the database 209 specifies the length and color-code of the tube to be produced. The programmable control unit 200 then causes the color-coding unit 106 and the cutting unit 108 to produce the requested tube as described above.

Those skilled in the art will understand that other methods exist of selecting tubes of desired color-codes and lengths, and that the above described embodiments are not exhaustive.

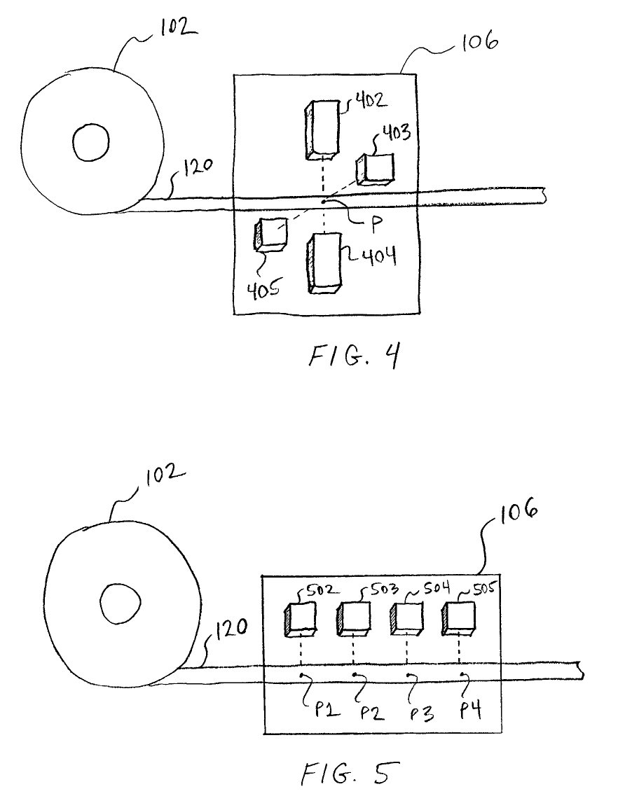

FIGS. 4 and 5 illustrate alternative embodiments of the color-coding unit 106. As shown in FIG. 4, color-coding unit 106 may have four print heads 402-405 that are circumferentially disposed about the tube 120. Each print head 402-405, moreover, may be associated with a different color. At any point in time, any one of the four print heads, e.g., 404, may be activated and deactivated by the programmable control unit 200 (FIG. 1) so as to apply the color, e.g., red, associated with the selected print head 404. Unit 200 may also activate more than one print head 402-405 so as to generate a tube having a plurality of colors. Furthermore, in the embodiment of FIG. 4, all four print heads 402-405 apply color at the same transverse point P on tube 120, although at different circumferential locations. Thus, the distance between point P and the location of the knife or sharp edge within cutting unit 108 represents the distance D used by the programmable control unit 200 in determining when to activate the cutting unit 108.

As shown in the embodiment of FIG. 5, color-coding unit 106 may have a plurality of print heads 502-505 that are arranged substantially along a line parallel to the transverse direction of tube 120. Again, programmable control unit 200 may activate and deactivate any one or more of print heads 502-505. Here, each print head 502-505 applies its respective color to a different transverse point P1 -P4 along the tube 120. In this case, the distance D (FIG. 1) varies depending on which print head 502-505 is being considered. With this embodiment, programmable control unit 200 may be programmed or configured with each distance between print head 502-505 and cutting unit 108 so as to accurately determine when to activate cutting unit 108 and when to deactivate the print heads 502-505. Alternatively, an average distance considering all four print heads 502-505 could be used.

Although only four print heads are shown in each of the embodiments of FIGS. 4 and 5, those skilled in the art will recognize that greater or fewer print heads may be employed.

It should be further understood that the system 100 may receive tubes of different sizes, e.g., diameters, for color-coding and cutting. More specifically, multiple drums 102, each carrying a tube having a different diameter, may supply tubing to the system 100, and each of these tubes may be routed through the various units of the system. In this embodiment, the color-coding unit 106 includes a series of print heads disposed about or along each tube and the cutting device(s) of cutting unit 108 is configured to cut each of the tubes. The programmable control unit 200, moreover, is preferably configured so as to selectively operate the tube puller 104, thereby drawing tubing from the desired drum, as well as selectively operate the print heads of color-coding unit 106 disposed about the selected tubing.

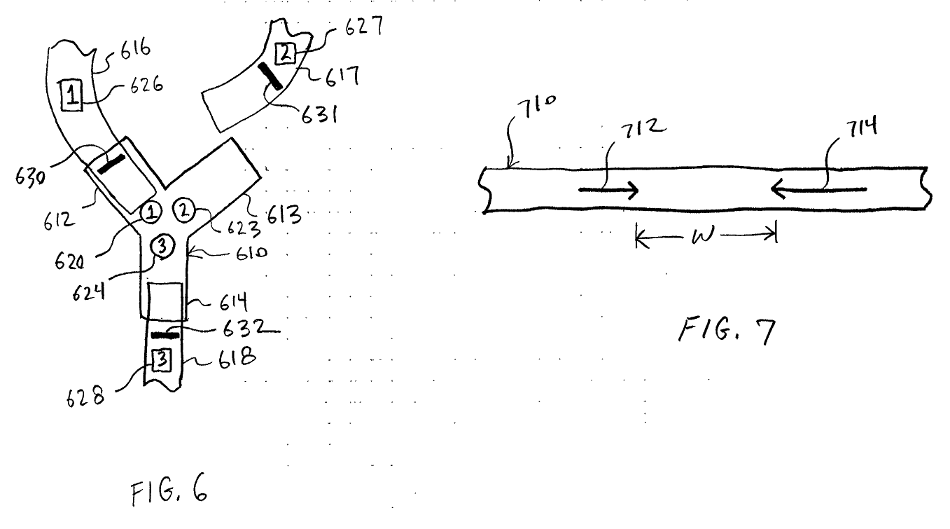

The flexibility of the system 200 of the present invention permits the creation of tubing designs and codings that are simply too expensive to be made with the prior art systems. For example, with the present invention, marks, codings or other instructions could be printed on tubes to facilitate the assembly process. FIG. 6, for example, is a highly schematic diagram of a Y-connector 610 having three connection points 612, 613 and 614 to which three tube segments 616, 617, and 618 are to be inserted in order to permit fluid communication among the three tubing elements. With prior art systems, it is possible that the wrong tubing element could be inserted into a connection point of the Y-connector 610. It is also possible that a given tubing element may not be fully inserted within its respective connection point, possibly resulting in a defective assembly. The system 200 of the present invention can be used to mark the three tubing elements so as to avoid these problems.

More specifically, the Y-connector could include separate identifiers for each connection point. For example, a first identifier 620, i.e., the numeral “1”, could be placed on connection point 612. A second identifier 623, i.e., the numeral “2”, could be placed on connection point 613 and a third identifier 624, i.e., the numeral “3”, could be placed on connection point 614. These identifiers could be molded or stamped into the form itself. Then, the programmable control unit 200 of system 100 could be configured to print a matching code, e.g., the numerals 1, 2 and 3, near the ends of the tube segments 616, 617, and 618, which are designated as reference numbers 626, 627 and 628, so that the tube segments can be easily matched up with their corresponding connection points. The system 100 could also print an insertion mark 630, 631 and 632 near the end of each tube segment. By continuing to feed the tube segments into the Y-connector 610 until the insertion marks are inside the respective connection points, as illustrated by mark 630, the assembler knows when the tube segments are fully inserted into the Y-connector 610.

The present invention can also be used to add markings to tubing that can be read or interpreted by a system operator to ensure that the corresponding disposable set has been properly loaded onto the respective medical equipment. For example, one or more tube segments of a disposable set must often be loaded into a valve or sensor located on the reusable medical equipment. If that portion of the tube segment that is loaded into the valve or sensor is too close to one of the tube's ends, undesirable stresses can be imposed on the disposable set. FIG. 7 is an illustration of a tube segment 710 having markings printed with the present invention that facilitate the loading of the tube segment 710 onto a valve or sensor. In particular, the system 100 can be used to print spaced-apart, opposing arrows 712, 714 at a specific point on the tube segment 710. Indeed, the arrows 712, 714 can be spaced apart by a selected width, W. The system operator can then use arrows 712, 714 to ensure that the correct portion of tube segment 710, i.e., that portion corresponding to width W, is inserted into the corresponding valve or sensor. That is, the tube segment 710 should be inserted so that the two arrows 712, 714 appear on either side of the valve or sensor, thereby preventing stresses from being imposed on the disposable set.

For tubing that is hung on an intravenous (IV) pole, markings could be applied to the tube to show how high fluid in the tube should be permitted to rise or climb up the tube.

System 100 can also be used to apply manufacturer-specific identifiers to tube segments. For example, the control unit 200 could direct the color-coding unit 106 to apply the manufacturer's name to tube segments for branding purposes. The color-coding unit 106 could similarly be directed to apply date of manufacture and/or manufacturer-specific codes or markings to the tube segments, such as manufacturing plant, tubing roll, lot, etc., for tracing purposes. These markings or codes could be in the form of bar codes that are readable by conventional bar code scanners. The color coding unit 106 could also be directed to apply an expiration date to the tube segments. Tubing used to assemble medical disposable sets is often made from a bio-compatible material. This material may include plasticizers that break-down over time. With system 100, such codes, markings, expiration dates, etc. could all be economically applied to tube segments.

The present invention can also provide significant advantages when working with multi-lumen tubes. More specifically, many disposable sets include one or more multi-lumen tube segments. Each lumen must typically be connected to a specific component, e.g., a storage bag, a connector, a supply of saline or anticoagulant, etc. Since multi-lumen tubes can often become twisted, it can be difficult for the assembler of the disposable set to be sure that he or she is connecting each end of the desired lumen to a particular component. This is especially true when working with long multi-lumen tubes. With system 100, codes or markings can be applied to the ends and/or along the lengths of multi-lumen tubes to help identify each specific lumen.

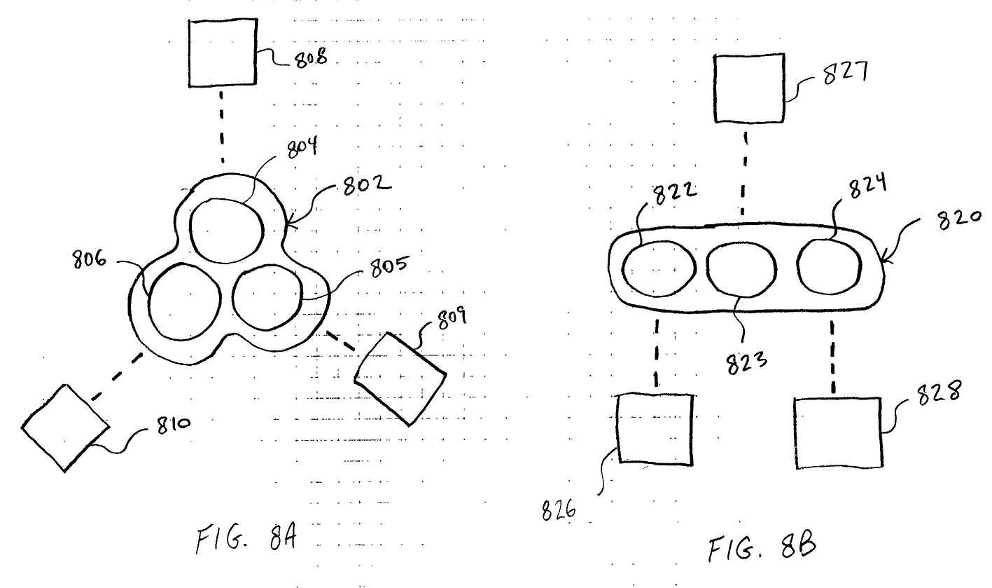

FIGS. 8A and 8B are highly schematic block diagrams of multi-lumen embodiments of the present invention. FIG. 8A shows a multi-lumen tube 802 in cross-section. The tube 802 defines three lumens 804, 805 and 806 that are arranged in a triangular manner. Disposed circumferentially about the tube 802 are three print heads 808, 809 and 810 of the color-coding unit 106 (FIG. 1). Each print head is positioned so as to print upon a portion of the tube that is clearly associated with only a single lumen. The codes or markings applied by print head 808, for example, are associated with lumen 804, while the codes or markings applied by print head 810 are associated with lumen 806. The print heads 808, 809 and 810, under the control of the control unit 200 (FIG. 1), can apply predetermined marks or codes to the tube to help keep track of the individual lumens. Print head 808, for example, could apply the numeral “1” to the ends or along the length of the tube 802, while print heads 809 and 810 would apply the numerals “2” and “3”, respectively. Thus, even if tube 802 becomes twisted after being color-coded and cut by the system 100, an assembler can easily match up the two ends of each specific lumen.

FIG. 8B shows a multi-lumen tube 820 in cross-section that defines three in-line lumens 822, 823 and 824. Disposed about the tube 820 are three print heads 826, 827 and 828 of the color-coding unit 106 (FIG. 1). Each print head 826, 827 and 828 is preferably positioned so as to apply marks or codes to portions of the tube 820 clearly associated with only a single lumen. Print heads 827 and 828, for example, apply marks or codes that are associated with lumens 823 and 824, respectively.

When the system 100 is operating on multi-lumen tubes, the tube puller 104 (FIG. 1) as well as the color-coding and cutting units 106 and 108 preferably include one or more rollers that are configured and arranged to ensure that the multi-lumen tube does not twist or rotate as it moves through the system 100.

Those skilled in the art will understand that the present invention will work easily as well with tubes having more or less lumens and/or that are arranged in other manners.

The system 100 can also be used to apply marks and/or codes that can be used or detected by a quality assurance (QA) system checking assembled disposable sets prior to their shipment to the customer. In particular, once they are assembled, disposable sets are often placed into a plastic container which can then be sterilized and sealed. The plastic container is typically molded to receive the specific components of the disposable set in a fixed manner. Once the assembled disposable set is placed in the plastic container, it could be passed through a QA system that checks for proper assembly. Specifically, the QA system could include a machine vision and checking system that looks at the disposable set. This system could confirm that the right tube segments were inserted into the correct manifold entries or connector entries by confirming that the numbers as illustrated in FIG. 6 match. By checking bar codes or other markings applied to the tube segments by the present invention, the QA system could also check that the right tube segments are all present or whether one or tubes or missing or whether one or more wrong tube segments were installed.

The QA system may also be configured to detect whether kinks in one or more tube segments are present. For example, the tube segments could include a continuous stripe or other mark that could be detected and evaluated for kinks, turns, etc. by the QA system.

As shown, with the present invention increases in safety can be achieved, first by facilitating proper assembly of disposable sets and second by facilitating their proper loading onto corresponding medical equipment. Those skilled in the relevant art will recognize that modifications to the above uses as well as other uses can be made with the present invention.

The foregoing description has been directed to specific embodiments of this invention. It will be apparent, however, that other variations and modifications may be made to the described embodiments with the attainment of some or all of their advantages. For example, the sequence and/or order of units 104, 106 and 108 within system 100 may be changed or altered. Accordingly, this description should be taken only by way of example and not by way of limitation. It is the object of the appended claims to cover all such variations and modifications as come within the true spirit and scope of the invention.

What is claimed is:

1. A variable color-coding and variable length cutting apparatus comprising:
a tube-feeding unit that provides a contiguous length of tube at a known speed;
a color-coding unit for receiving the tube from the tube-feeding unit;
a tube-cutting unit for receiving the tube from the tube feeding unit; and
a programmable controller unit operatively coupled to the color-coding unit and the tube-cutting unit that uses the known speed to determine a length of tube passing through the color-coding unit to thereby transmit start/stop color-coding signals and to determine the length of the tube passing through the tube-cutting unit to thereby transmit a tube-cut signal.

2. The apparatus of claim 1 further comprising:
a database having a plurality of entries, each entry having a particular color and length combination for application to the contiguous tube, the database accessible by the programmable controller unit, wherein the programmable controller unit uses the datas base to dynamically determine a color to be applied to the tube and a length to which the tube is to be cut, thereby allowing the apparatus to produce variable color-coding and variable length-cutting of tubes on demand.

3. The apparatus of claim 1 further comprising:
a database of disposable sets, at least one color code and length tube data associated with each disposable set, the database accessible by the programmable controller unit, wherein the programmable controller unit uses the database to dynamically determine a corresponding color to be applied to the tube and a corresponding length to which the tube is to be cut when a given disposable set is selected, thereby allowing the apparatus to produce variable color-coding and variable length-cutting of tubes on demand.

4. The apparatus of claim 3 further comprising:
an interface to make a medical equipment selection.

5. The apparatus of claim 1 further comprising:
a database of barcodes that correspond to particular colors and particular lengths, the database is associated with the programmable controller unit, wherein the programmable controller unit uses the database to dynamically determine a color to be applied to the tube and a length the tube is to be cut when the corresponding barcode is selected, thereby allowing the apparatus to produce variable color-coding and variable length-cutting of tubes on demand.

6. The apparatus of claim 5 further comprising an interface to make a barcode selection.

7. The apparatus of claim 1 further comprising a tube uncoiler that contains a contiguous length of tube.

8. The apparatus of claim 1 further comprising a tube sorting device.

9. A variable color-coding and variable length-cutting apparatus comprising:
means for unwinding a contiguous length of tube at a known speed;
means for color-coding the tube;
means for cutting the tube; and
means for receiving and using the known speed to determine a length of tube passing through the color-coding means to thereby transmit start/stop color-coding signals and to determine the length of the tube passing through the tube-cutting means to thereby transmit tube-cut signal.

10. The apparatus of claim 9 further comprising:
means for storing a plurality of entries, each entry having a particular color and length that is applied to the contiguous tube, the storing means is associated with the receiving means, wherein the receiving means uses the storing means to dynamically determine a color to be applied to the tube and a length the tube is to be cut, thereby allowing the apparatus to produce variable color-coding and variable length-cutting of tubes on demand.

11. A method for producing a variable color-coded and length tubes, the method comprising the steps of:
unwinding a contiguous length of tube at a known speed;
providing a color-coding unit;
providing a tube-cutting unit; and
using a programmable controller unit to receive and use the known speed to determine a length of tube passing through the color-coding unit to thereby transmit start/stop color-coding signals and to determine the length of the tube passing through the tube-cutting unit to thereby transmit tube-cut signal.

12. The method of claim 11 further comprising the steps of:
providing a database having a plurality of entries, each entry having a particular color and length that is applied to the contiguous tube;
associating the database with the programmable controller unit, wherein the programmable controller unit uses the database to dynamically determine a color to be applied to the tube and a length the tube is to be cut, thereby allowing the apparatus to produce variable color-coding and variable length-cutting of tubes on demand.

13. The method of claim 11 further comprising the steps of:
providing a database of medical equipment and at least one color code and length tube data associated with a medical equipment;
associating the database with the programmable controller unit, wherein the programmable controller unit uses the database to dynamically determine a color to be applied to the tube and a length the tube is to be cut when the medical equipment is selected, thereby allowing the apparatus to produce variable color-coding and variable length-cutting of tubes on demand.

14. The method of claim 13 further comprising the step of providing an interface to make a medical equipment selection.

15. The method of claim 11 further comprising the steps of:
providing a database of barcodes that correspond to particular colors and particular lengths;
associating the database with the programmable controller unit, wherein the programmable controller unit uses the database to dynamically determine a color to be applied to the tube and a length the tube is to be cut when the corresponding barcode is selected, thereby allowing the apparatus to produce variable color-coding and variable length-cutting of tubes on demand.

16. The method of claim 11 further comprising the step of providing an interface to make a barcode selection.

17. The method of claim 11 further comprising the step of providing a tube uncoiler that contains a contiguous length of tube.

18. The method as in claim 11 further comprising the step of providing a tube sorting device.
